(19) United States
(12) Patent Application Publication
(10) Pub. No.: US 2014/0079351 A1
(43) Pub. Date: Mar. 20, 2014

(54) MILLIMETER-WAVE ELECTRO-OPTIC MODULATOR

(71) Applicant: PHASE SENSITIVE INNOVATIONS, INC, Newark, DE (US)

(72) Inventors: Julien Macario, Newark, DE (US); Peng Yao, Newark, DE (US); Dennis W. Prather, Newark, DE (US)

(73) Assignee: PHASE SENSITIVE INNOVATIONS, INC, Newark, DE (US)

(21) Appl. No.: 13/623,525

(22) Filed: Sep. 20, 2012

(51) Int. Cl. G02F 1/01; C25D 7/00

(52) U.S. Cl. CPC G02F 1/011; C25D 7/00
USPC 385/3; 205/159

(57) ABSTRACT

A lithium niobate-based electro-optic modulator may include a ridged optical waveguide structure and/or a thinned substrate.

### STATEMENT OF GOVERNMENT SUPPORT

This work was supported by the Defense Advanced Research Projects Agency-Microsystems Technology Office, under Contract No. ______, and by the Office of Naval Research-C4ISR Applications Division, under Contract No. ______. The Government has certain rights in the invention.

### FIELD OF THE INVENTION

Embodiments of the invention may relate to millimeter-wave electro-optic modulators, particularly such modulators fabricated using lithium niobate.

### BACKGROUND

Existing electro-optic modulators have been limited by their structure to 110 GHz bandwidths or to narrow operational band widths at higher frequencies in the millimeter-wave range (30-300 GHz). In particular, known lithium niobate (LiNbO₃: hereinafter, “LN”) electro-optic modulators are often limited in bandwidth by poor index matching and/or radio frequency (RF) energy leaking into the substrate. It would be desirable in some applications, such as high-speed data transfer and millimeter-wave imaging, to be able to overcome such issues, in order to obtain electro-optic modulators that operate at significantly higher speeds.

### BRIEF SUMMARY OF EMBODIMENTS OF THE INVENTION

Various embodiments of the invention may involve several techniques, such as ridged co-planar waveguide (CPW) structure and/or thin LN substrate, for obtaining an electro-optic phase modulator. As a result of such techniques, a very good optical and RF index matching may be achieved, and substrate modes may be reduced or eliminated, allowing, for example, a 300 GHz operational bandwidth. Embodiments of the invention may include such modulators and/or methods for fabricating such modulators.

### BRIEF DESCRIPTION OF THE DRAWINGS

Various embodiments of the invention will now be described in conjunction with the accompanying drawings, in which:

FIG. 1 shows an example structure of an electro-optic modulator according to an embodiment of the invention;

FIG. 2 shows a flow diagram of an example of a process for fabricating an electro-optic modulator according to an embodiment of the invention;

FIG. 3 shows, by means of diagrams, an example of a process for fabricating an electro-optic modulator according to an embodiment of the invention;

FIG. 4, comprising FIGS. 4a and 4b, shows examples of aspects of a modulator according to an embodiment of the invention; and

FIG. 5 shows an example of a modulation spectrum obtained using a modulator according to an embodiment of the invention.

### DETAILED DESCRIPTION OF EMBODIMENTS OF THE INVENTION

Various embodiments of the invention may include a lithium niobate (“LN”) electro-optic phase modulator that may provide wide bandwidths, for example, but not limited to, a 300 GHz modulation bandwidth. Embodiments of the modulator may be based on a traveling wave electrode, which may, e.g., be made of gold, and which may be built on top of a waveguide, e.g., a titanium (Ti) waveguide, that may be diffused in a LN substrate.

In some embodiments, it may be desirable to operate over the full millimeter-wave spectrum (30-300 GHz). In order to operate at back end of the millimeter-wave (mmW) spectrum at 300 GHz, it may be necessary for modulated light traveling in the waveguide and a radio-frequency (RF) modulating signal propagating on the traveling wave electrode to travel at the same precise speed. Moreover, it may be desirable to eliminate, to the extent possible, substrate modes resulting from coupling of the RF energy into the substrate, which may ensure an optimal interaction between RF and optical signals.

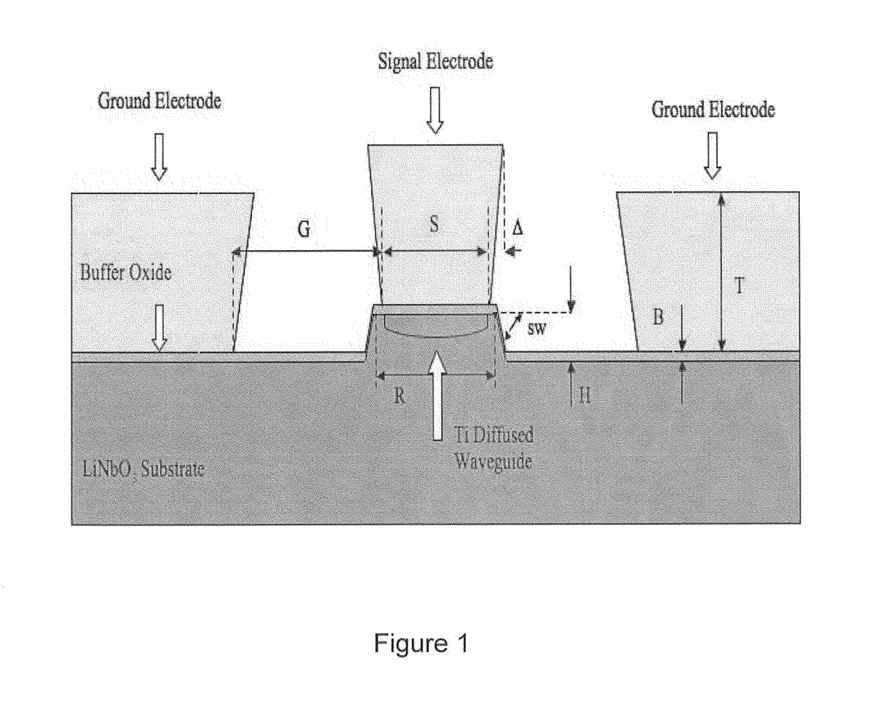

As discussed above, and as shown in FIG. 1, an electro-optic modulator according to an embodiment of the invention may comprise a traveling-wave modulator having a signal electrode (“Signal Electrode” in FIG. 1), which may be designed as a transmission line, overlaying an optical waveguide (“Ti Diffused Waveguide” in FIG. 1). A modulating mmW signal on the signal electrode may travel in the same direction as the modulated optical signal as they interact along the length of the signal electrode and may induce a phase change of the optical carrier.

The phase change may be directly proportional to the integral of the electrical field crossing the optical waveguide over the length of the signal electrode. As a result, the conversion efficiency of the device may depend on the strength of the interaction between the electrical field and the optical field along the length of the electrode. Therefore, one may wish, ideally, for both fields to travel at the same speed during their entire interaction. However, this velocity matching may represent a challenge, as the effective index of the mmW in LN is typically about 6, whereas it may be only 2.19 for the optical field for a 1550 μm wavelength in LN. This discrepancy in effective index may be addressed, in embodiments of the invention, by means of a ridge structure combined with thick electrodes and the deposition of a silicon dioxide layer between the signal electrode and the optical waveguide, shown as the “Buffer Oxide” in FIG. 1. This combination of features may reduce the mmW effective index down to 2.19. The ridge and the thick electrodes may accomplish this by pulling some of the electrical field from the LN of high index up into the air of lower index.

The buffer layer may also contribute to reducing the mmW effective index, as well as preventing the optical field from scattering off the RF electrode. However, the buffer layer may also reduce the strength of the electric field crossing the optical waveguide. Therefore, one may need to set a thickness of the buffer layer to allow optimal interaction between the fields as well as index matching, which may be determined based on analytical and/or empirical methods.

Other parameters than index matching may be optimized in order for the modulator to operate at the desired bandwidth. One may wish to have the input impedance of the modulator be as close as possible to 50Ω to minimize the radio frequency (RF) insertion loss. Moreover, one may wish to keep the half-wave voltage V_{π} and conduction and dielectric losses as low as possible. An optical and an electrical analysis may be performed to optimize the profile of the modulator structure in terms of efficiency. In an example of one such analysis by the inventors, to which the invention is not limited, it was determined that the ridge height H, the ridge width R, the electrode height T, the electrode width S, the gap G, the buffer layer B may be set to 3.6 μm, 11 μm, 24 μm, 8 μm, 25 μm and 0.9 μm, respectively. The LN substrate may also be thinned down, which may help to eliminate substrate modes coupling; this will be discussed further below.

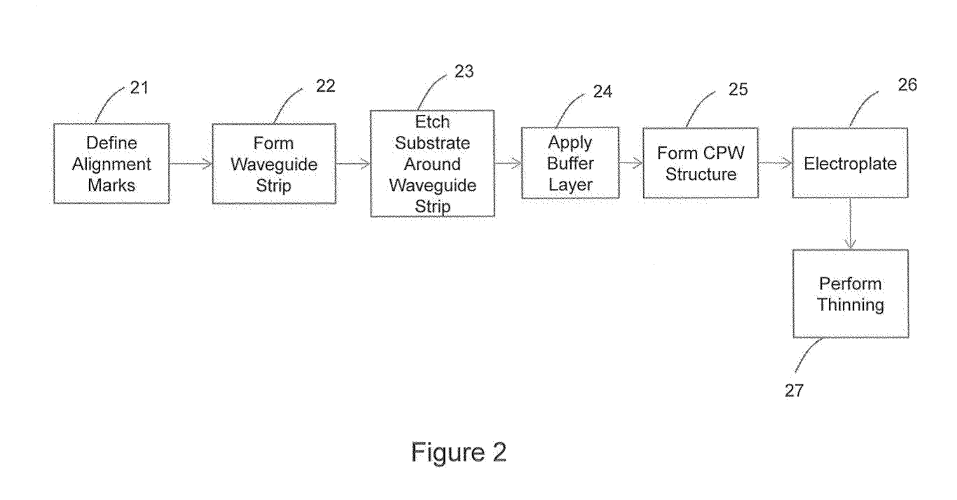

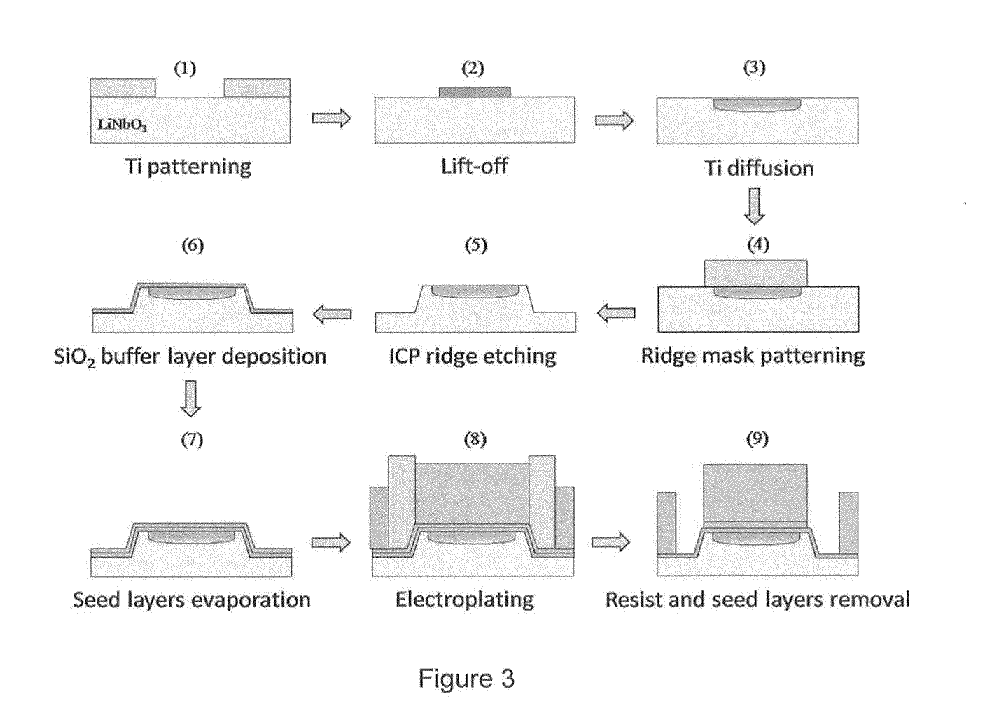

In order to obtain such a modulator, a technique, such as the process shown in FIG. 2 and/or FIG. 3, may be followed, in various embodiments of the invention. The process may include defining alignment marks 21. Alignment marks may be defined on a substrate, e.g., a LN substrate, for example, by lithography and may be dry-etched in a Induced Coupled Plasma (ICP) Reactive Ion Etching (RIE) system in a chlorine environment. A waveguide strip may then be formed 22 on the substrate. In an example implementation of an embodiment, a 6 μm wide strip may be patterned on the substrate along the x-axis of the substrate using lithography. A titanium (Ti), e.g., but not limited to, approximately 100 nm in thickness, may then be evaporated on the top surface of the substrate, and a lift-off process may be used to dissolve the photoresist (see FIG. 3, (1)-(2)). The remaining Ti strip may then be diffused in a furnace; in an example implementation of such techniques, this may be performed, for example, at 1050° C. for 10 hours in an oxygen environment (see FIG. 3, (3). After forming the waveguide strip, the LN surrounding the waveguide may be etched 23 to create ridge structure (see, e.g., FIG. 3, (4)-(5)). In an example implementation, the ridge structure etching may be performed to a depth of 3.6 μm and a width of 10.5 μm (however, the invention is not thus limited); this may be done, for example, in an ICP RIE system in a chlorine environment. A buffer layer may then be formed 24 on top of the substrate (see FIG. 3, (6)). In an example implementation of an embodiment of the invention, a 900 nm thick silicon dioxide (SiO₂) buffer layer may be deposited on the substrate top surface using plasma-enhanced chemical vapor deposition (PECVD) process. The SiO₂ buffer layer may then be annealed at 600° C. for 6 hours. A CPW structure may then be formed 25. This may be done, e.g., by lithography. In particular, a high aspect-ratio CPW structure may be defined by lithography. The resulting open surface may then be electroplated 26, using, e.g., a gold (Au) solution, to buildup CPW electrodes, which may, e.g., be 25 μm thick. The lithography 25 may be preceded by the evaporation of one or more seed layers, e.g., Ti/Au/Ti, and this may be used to help define the electrode shapes (see FIG. 3, (7)-(8)).

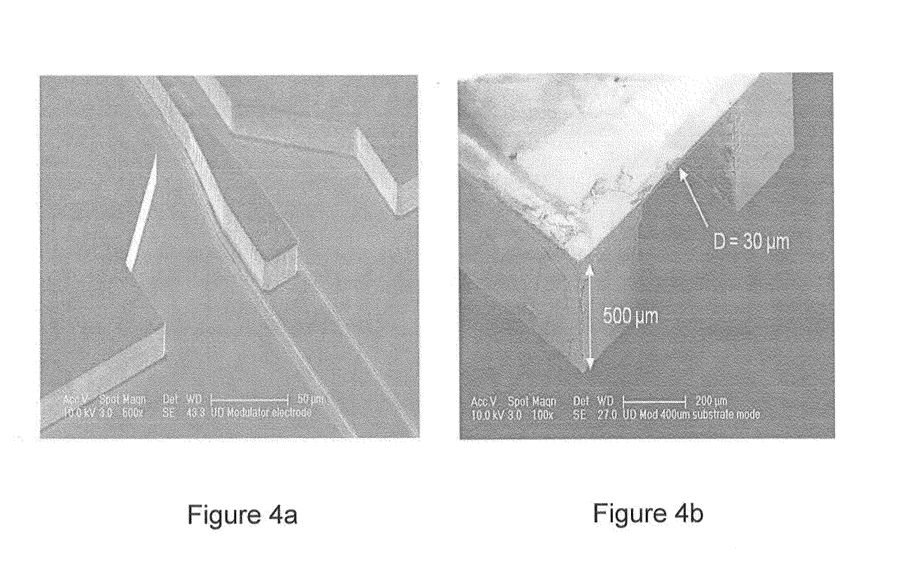

FIG. 4a shows an example of a resulting CPW gold-plated structure with the LN substrate etched on each side thereof.

Following the above process, resist and seed layers may be removed, as shown, e.g., in FIG. 3, (9).

Returning to FIG. 2, the modulator may then be diced, and both end faces may be polished. The modulator may then be thinned 27. In an embodiment of the invention, the modulator may be thinned down to less than 39 μm, which may serve to reduce or eliminate substrate mode coupling over a desired operating range, e.g., the 0-300 GHz range. For this thinning process, a 400 μm wide groove may be machined underneath the signal electrode over the entire length of the modulator. FIG. 4b shows an example of an end face of a resulting modulator structure that has been thinned to 30 μm. Further details of examples of thinning processes that may be used may be found in co-pending U.S. Provisional Patent Application No. 61/537,373, filed on Sep. 21, 2011, and in co-pending U.S. patent application Ser. No. ______, filed concurrently herewith, and entitled, “System and Method for Substrate Thinning in Electro-Optical Modulators,” assigned to the assignee of the present application; both of these applications are incorporated by reference herein.

Optical fibers may be attached to the resulting modulator. In an embodiment of the invention, polarization maintained optical fibers may be aligned and bonded to both end faces of the modulator using UV curable epoxy.

It is noted that variations on some of the above-noted techniques may be possible and that the order of operations may be varied under some circumstances.

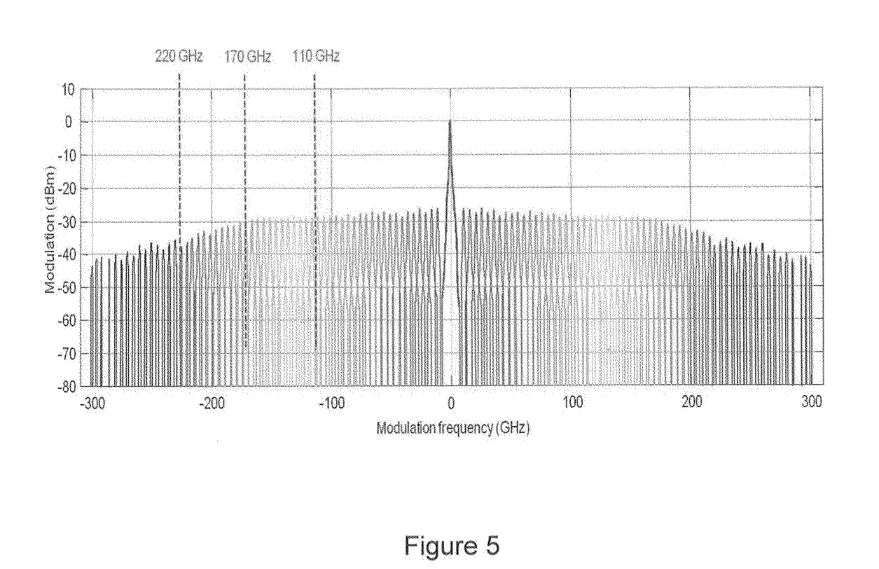

FIG. 5 shows a 300 GHz-wide optical modulation spectrum obtained using a modulator according to an embodiment of the invention. In this figure, each pair of sidebands centered about an optical carrier frequency represents the energy for a given frequency upconverted to optical energy by the electro-optic effect of the LN.

Various embodiments of the invention have now been discussed in detail; however, the invention should not be understood as being limited to these embodiments. It should also be appreciated that various modifications, adaptations, and alternative embodiments thereof may be made within the scope and spirit of the present invention.

What is claimed is:

1. An electro-optic modulator, comprising:
a lithium niobate substrate comprising an optical waveguide formed therein and configured to conduct an optical carrier signal, the optical waveguide having a ridge structure formed above a surface of the substrate; and
an electrode formed on top of the ridge structure of the optical waveguide and configured to carry an electrical modulating signal.

2. The electro-optic modulator of claim 1, wherein the optical waveguide comprises a titanium diffused waveguide.

3. The electro-optic modulator of claim 1, further comprising an oxide buffer layer formed between the electrode and the optical waveguide.

4. The electro-optic modulator of claim 3, wherein the oxide buffer layer extends beyond the ridge structure, and wherein the electro-optic modulator further comprises one or more ground electrodes formed on the oxide buffer layer.

5. A method of fabricating an electro-optic modulator, the method comprising:
forming an optical waveguide strip on a lithium niobate substrate, thereby forming a ridge on the lithium niobate substrate; and
forming a metal electrode above the ridge, the metal electrode being configured to conduct an electrical modulating signal to enable modulation of the electrical modulating signal onto an optical signal carried in the optical waveguide strip.

6. The method of claim 5, wherein forming the optical waveguide strip comprises:
diffusing titanium into a region in which the ridge is to be formed to form a titanium-diffused region.

7. The method of claim 6, wherein forming the optical waveguide strip further comprises etching along sides of the titanium-diffused region to form the ridge.

8. The method of claim 5, wherein forming the metal electrode comprises electroplating at least one metal layer onto the substrate.

9. The method of claim 8, wherein forming the metal electrode further comprises evaporating one or more metallic seed layers onto the substrate prior to said electroplating.

10. The method of claim 5, further comprising forming a buffer oxide layer on the substrate prior to forming the metal electrode.

11. The method of claim 5, further comprising thinning the substrate after forming the electro-optic modulator.
